(19) United States
(12) Patent Application Publication
(10) Pub. No.: US 2021/0324204 A1
(43) Pub. Date: Oct. 21, 2021

(54) LIGHT-INDUCED COLD APPLICATION OF A THICK-LAYERED ANTICORROSIVE COATING WITH CONTROLLABLE KINETICS

(71) Applicant: Pfinder KG, Boeblingen (DE)

(72) Inventors: Judith Schwaderer, Tuebingen (DE); Christian Schaller, Neuhausen (DE); Karsten Lessmann, Rottenburg (DE); Hans-Friedrich Staengle, Marbach (DE); Mark Bader, Kirchheim (DE)

(21) Appl. No.: 17/346,517

(22) Filed: Jun. 14, 2021

Related U.S. Application Data
(63) Continuation of application No. PCT/EP2019/085660, filed on Dec. 17, 2019.

(30) Foreign Application Priority Data
Dec. 20, 2018 (DE) 10 2018 133 035.9

(51) Int. Cl. C09D 5/08; B05D 3/06; B05D 7/14; B05D 1/02; C09D 7/63; C09D 133/08; C09D 7/65

(52) U.S. Cl. CPC C09D 5/08; B05D 3/067; B05D 7/142; B05D 2502/00; C09D 7/63; C09D 133/08; C09D 7/65; B05D 1/02

(57) ABSTRACT

An anti-corrosive agent, a method for anticorrosive coating of a component and a system for anti-corrosive coating of a component are provided. The anti-corrosive agent, which is a body-cavity preserving agent, an agent for underbody sealing, an agent for permanent protective coating for storage and transportation or an agent for temporary protective coating for storage and transportation, is intended for the corrosion protection of a component, in particular an automotive part. The anti-corrosive agent can be applied without additional heating, is radiation-induced radical and/or cationic, preferably in the case of thick layers, crosslinking and has application-specific, controllable reaction kinetics and adapted heat resistance.

### CROSS-REFERENCE TO RELATED APPLICATIONS

This application is a continuation of international patent application PCT/EP2019/085660, filed on Dec. 17, 2019 designating the U.S., which international patent application has been published in German language and claims priority from German patent application DE 10 2018 133 035.9, filed on Dec. 20, 2018. The entire contents of these priority applications are incorporated herein by reference.

### BACKGROUND

The present invention relates to anti-corrosion coatings. In particular, the present invention relates to an anti-corrosive used inter alia in the cavity preservation of vehicles. This invention therefore relates to cavity preservation (CP) systems, which are preferably applied by spray application. The anti-corrosives of the invention are cavity preservation agents, for example agents for underbody protective coating, agents for permanent protective coating for storage and transport, or agents for temporary protective coating for storage and transport. The anti-corrosives are also intended for the corrosion protection of a component, in particular of a motor vehicle part, and can be applied without additional heating, undergo radiation-induced free radical and/or cationic crosslinking, preferably in thick layers, and have application-based, controllable reaction kinetics and an adjusted heat resistance.

Cavity preservation (CP) systems are known in particular from the automotive industry. They involve the application of an anti-corrosive into cavities such as those found in vehicle bodies. Once applied, for example on a metallic substrate, CP systems offer good protection against corrosion initiated for example by the action of water and moist ambient air and in some cases intensified by the presence of salts, e.g. road salt.

In general, two different types of CP systems are described in the prior art: flood waxes and spray waxes. Customary CP systems for spray application comprise waxes and/or resins, functional additives such as for example anti-corrosion additives, formulation additives such as for example rheology aids or dispersing aids, inorganic fillers that are dispersed in an aqueous medium (so-called aqueous CP systems) or a nonpolar organic solvent (so-called solvent CP systems). There are also so-called 100% CP systems that are solvent-free.

The advantages of solvent CP systems are their easy handling, universal usability, and chemically-effected crosslinking. Disadvantages are the content of volatile organic compounds (VOCs) and the labeling requirement. The advantages of aqueous CP systems are that they do not contain VOCs, that the CP system is suitable for cold application, and that the aqueous CP system also has the best heat stability. Disadvantages are the absence of chemical crosslinking and poorly controllable rheology, and also a climate-determined, variable drying time. The advantages of 100% CP systems are optimal process control and chemical crosslinking. A disadvantage is the emission of elimination products. In addition, an oven or IR emitter is needed for gelation.

In order to achieve even distribution of the sprayed CP system in the installable components and construction elements to be protected, products having low viscosity are generally used in order to achieve even wetting of the component surface and good penetration of folds. Here there is a trade-off between the need for low viscosity on the one hand and the need, once all relevant parts of the components have been wetted, for the CP system to cease to be flowable on the other hand in order to prevent the CP system from dripping out of the puncture holes or application points provided for application of the CP in the regions to be protected, e.g. from a body. Depending on the component, a lower or higher viscosity is needed in order to enable the CP system to run throughout the component. However, since it is not possible to individually set the rheology for each puncture hole or for each application point, an average rheology is selected for the material such that the components are wetted as completely as possible and with only a small degree of dripping occurring despite this.

In the case of solvent CP systems and aqueous CP systems, the necessary increase in viscosity after application is achieved by evaporation of the volatile components. With 100% systems, this increase in viscosity occurs through a thermally initiated process step. This increase in temperature (e.g. 1 minute at 60° C.) initiates gelation of the CP system, the so-called DropStop, which prevents the CP system from dripping and thus ensures process reliability. Disadvantages here are that the use of ovens incurs energy costs for customers (original equipment manufacturer, OEM), moreover it is difficult to ensure a constant temperature increase across all layer thicknesses.

Once the medium has evaporated or the CP system has gelled, a film that protects against corrosion forms on the coated surface. In the further course of functioning of the CP, good heat stability is necessary. This means that, when the component is heated again, the applied CP system must not become liquid again or run off and the solidity of the anti-corrosion films within a range from −20 to 95° C. is ensured. Heat stability is in solvent CP systems and 100% CP systems generally achieved through chemical crosslinking of components contained therein, for example the oxidative drying of alkyd resins, which takes approximately 3 to 5 days to complete.

From an overall perspective, the application of CP systems is thus a two-stage process. The first stage consists of the directed application and immediate flow with adequate penetration of the CP system (into any openings and depressions on the component) and an—in the optimal case controllable—increase in viscosity. The second stage consists of the chemical crosslinking and evaporation of volatile components during and/or after the increase in viscosity, so as to achieve long-lasting heat stability.

This lengthy drying/crosslinking time, often incomplete drying, and the average rheology of the material for all individual application points must for conventional CP formulations be regarded as disadvantageous. For this reason, drip zones are often required for the controlled dripping of undried CP systems, as is masking of certain components and/or component parts, such as for example rocker panels. This increases the process costs for preservation and often requires manual post-treatment to remove remnants of the CP system. Another disadvantage of oxidatively crosslinking CP systems is the formation of elimination products, mainly C₅ to C₉ aldehydes, which can contribute to overall emissions in the vehicle interior and to odor, for which every OEM specifies strict and individual limit values, some of which can be achieved only with great effort. Here, too, there is something of a trade-off: In order to ensure that the CP system is easy to apply and has good heat stability, a one-component (1C) crosslinking reaction is desirable. However, the technology based on alkyd resins that is used nowadays gives rise to emissions and odor. On the other hand, other binder technologies are as yet unable to fully meet the necessary criteria such as a 1C system, absence of labeling requirements, storage stability, ability to undergo crosslinking without increasing the temperature (above room temperature), etc.

For example, DE 10 2004 047 175 A1 relates to an anti-corrosive for cavities in vehicle bodies and to a process for the application thereof. In this process, a foamable anti-corrosive is introduced into the region of the cavity before production of a cavity. The body containing the cavity is subsequently exposed to conditions that cause the foamable anti-corrosive to foam, as a result of which the foamed anti-corrosive wets the inner surface of the cavity and adheres to it in a thin layer at least.

It is therefore desirable to provide an anti-corrosive that, within the scope of the application options afforded by the prior art, provides optimal corrosion protection for a component. The anti-corrosive should involve little cleaning and finishing work, if possible none at all. This means that any waste requiring disposal can be partially or completely avoided. For example, dripping after application can be partially or completely prevented without needing to laboriously mask components or parts of components, for example rocker panels. In addition, the anti-corrosive should be low-emission, in particular low-VOC and low-odor, and it should be possible to apply it cold.

### SUMMARY

Based on the prior art, the object of the present invention is therefore to provide an anti-corrosive, a process for the anti-corrosion coating of a component, and a system for the anti-corrosion coating of a component in which the abovementioned disadvantages are resolved. Another object of the present invention is to provide an anti-corrosive characterized by a drying/curing rate and crosslinking that are calculated and individually controllable. Yet another object of the present invention is to provide an anti-corrosive that is as thick-layered as possible.

The present invention therefore provides an anti-corrosive that is a cavity preservation agent, an agent for underbody protective coating, an agent for permanent protective coating for storage and transport, or an agent for temporary protective coating for storage and transport. The anti-corrosive is intended for the corrosion protection of a component, in particular of a motor vehicle part. The anti-corrosive can be applied without additional heating, undergoes radiation-induced free radical and/or cationic crosslinking, preferably in thick layers, and has application-based, controllable reaction kinetics and an adjusted heat resistance.

The anti-corrosive of the invention has a photoinitiator for this purpose. According to the present invention, the anti-corrosive may be any commercially available anti-corrosive that either contains a photoinitiator from the outset or is admixed with a photoinitiator.

The present invention additionally provides an anti-corrosive. The anti-corrosive comprises or consists of: 0.1% to 10.0% by weight of at least one photoinitiator, 0.0% to 0.1% by weight of a photosensitizer, 1.0% to 40.0% by weight of a binder, 0% to 10.0% by weight of a reactive diluent, 0.0% to 10.0% by weight of an additive, 5.0% to 50.0% by weight of an oil, 1.0% to 20.0% by weight of a wax, 0.0%, for example 1.0%, to 40.0% by weight of an anti-corrosion additive, and 0.0% to 20.0% by weight of a filler and/or a pigment, based on 100% by weight of the anti-corrosive, the anti-corrosive including at least one photoinitiator, the photoinitiator and the optional photosensitizer being tailored to the absorption of radiation, wherein the anti-corrosive is at the end of irradiation solid or else solidifies in a time-adjusted manner.

A process of the invention for the anti-corrosion coating of a component includes or consists of: applying an anti-corrosive to the component, the anti-corrosive including at least one photoinitiator and optionally a photosensitizer, irradiating the anti-corrosive with radiation tailored to absorption by the at least one photoinitiator and by any optional photosensitizer, wherein the anti-corrosive is at the end of irradiation solid or else solidifies in a time-adjusted manner. The anti-corrosive is preferably the anti-corrosive of the invention.

The present invention additionally concerns a system for the anti-corrosion coating of a component, comprising or consisting of: an anti-corrosive, preferably an anti-corrosive of the invention, that is applied to the component, the anti-corrosive including at least one photoinitiator and optionally a photosensitizer, at least one radiation source for the irradiation—which can take place before or after application and inside or outside the component—of the anti-corrosive with radiation tailored to absorption by the at least one photoinitiator and by any optional photosensitizer, wherein the anti-corrosive is at the end of irradiation with the at least one radiation source solid or else solidifies in a time-adjusted manner.

The use of an anti-corrosive for the anti-corrosion coating of a motor vehicle component is provided. The anti-corrosive is a cavity preservation agent or an agent for underbody protective coating and comprises or consists of:

0.1% to 10.0% by weight of at least one photoinitiator,

0.0% to 0.1% by weight of a photosensitizer,

1.0% to 40.0% by weight of a binder,

0% to 10.0% by weight of a reactive diluent,

0.0%, for example 0.1%, to 10.0% by weight of an additive,

5.0% to 50.0% by weight of an oil,

1.0% to 20.0% by weight of a wax,

0.0%, for example 1.0%, to 40.0% by weight of an anti-corrosion additive, and

0.0% to 20.0% by weight of a filler and/or a pigment, based on 100% by weight of the anti-corrosive, the anti-corrosive including at least one photoinitiator, the photoinitiator and/or the photosensitizer being tailored to the absorption of radiation, wherein the anti-corrosive is at the end of irradiation solid or else solidifies in a time-adjusted manner, the coating having a thickness of 50 to 8000 μm.

In addition, a process for the anti-corrosion coating of a motor vehicle component is provided. The anti-corrosive is a cavity preservation agent or an agent for underbody protective coating and the process includes or consists of:

applying an anti-corrosive to the component, the anti-corrosive including at least one photoinitiator and optionally a photosensitizer,

irradiating the anti-corrosive with radiation tailored to absorption by the at least one photoinitiator and by any optional photosensitizer, wherein the anti-corrosive is at the end of irradiation solid or else solidifies in a time-adjusted manner, the anti-corrosive comprising or consisting of:

0.1% to 10.0% by weight of at least one photoinitiator,

0.0% to 0.1% by weight of a photosensitizer,

1.0% to 40.0% by weight of a binder,

0% to 10.0% by weight of a reactive diluent,

0.0%, for example 0.1%, to 10.0% by weight of an additive,

5.0% to 50.0% by weight of an oil,

1.0% to 20.0% by weight of a wax,

0.0%, for example 1.0%, to 40.0% by weight of an anti-corrosion additive, and

0.0% to 20.0% by weight of a filler and/or a pigment, based on 100% by weight of the anti-corrosive, the coating having a thickness of 50 to 8000 μm.

In the context of the present invention, it was found that light-induced cold application allows a two-stage drying process of a typical 100% CP system—i.e. the gelation of the product through the use of temperature and the subsequent chemical crosslinking of the alkyd resins, as well as the purely physical drying of an aqueous CP system—to be replaced by spray application of the CP system followed by exposure/irradiation by means of suitable light sources. The exposure can take place either directly before or during application (simultaneous exposure and application) or in a subsequent process step.

The light source can be used to excite reactive substances in the corrosion coating, thereby initiating chemical crosslinking of the anti-corrosive applied to a component. The CP system is thus able to undergo crosslinking a few seconds after exposure to light and requires short drying times of, for example, 5 minutes or less. Based on a desired flow of the CP system on the component, the crosslinking can be controlled and accordingly time-delayed or can take place over a longer period of e.g. 5 minutes to 12 hours, such as 10 min to 6 hours, 20 minutes to 3 hours, or 30 min to 1 hour. The applied coating is preferably heat resistant within a period of 15 min to 45 min, such as 20 min to 40 min, 25 min to 35 min, or 30 min. The desired onset of solidification and the degree of crosslinking can be controlled via the time of exposure and also via the light intensity. This makes it possible to individually adjust and control the rheology and the flow behavior of the product over the duration of exposure. The light-induced cold-application method for CP systems thus at the same time represents an alternative to the two-stage process (temperature increase and oxidative chemical crosslinking). Moreover, the elimination products arising during the oxidative crosslinking, and thus the formation of emissions and odor, can thereby be avoided. The exposure can take place either directly, during application of the anti-corrosive, or in a subsequent process step.

The use of light as an initiator for chemical crosslinking allows the customer to reduce energy costs and achieve time savings in the application of the CP system. The light intensity and duration can moreover be set on a customer-specific basis and even individually for each application point of a component. This makes it possible, depending on the geometry of the component, to control the course of CP so that the optimal and consistent coating thickness can be ensured without possible running of the CP system at other points. Since the setting for the irradiation intensity and/or duration can be easily adjusted, it is possible to use the same material for different customer requirements or application lines, and also components, and still in each case permit the best coating for the individual component. This permits a “one-component material strategy” with tailored application to the component, for example rocker panels, trunk lid or door. There is therefore no need for other additives that modify the rheology, in particular a DropStop additive.

The present anti-corrosive can be applied and cured as part of a low-VOC, low-emission, low-odor, light-induced cold application with controllable kinetics. Enhanced workplace safety is in this connection ensured.

The present invention can generally be used for all thick-layered anti-corrosion coatings such as for example aqueous, solvent-containing, and 100% CP systems. In addition, it can also be used in the field of coatings for underbody protection (UBP) and protective coatings for permanent or temporary storage and transport. The advantage here is a more rapid mar resistance and rain resistance through the use of suitable materials.

Adjustment of the flow behavior and penetration behavior of the thick-layered anti-corrosion coating to the geometry of the component is made possible through the use of a light-induced cold-application method with complete drying or crosslinking, in which the duration of irradiation and light intensity can be easily adjusted. This ensures a high level of process reliability and allows individual adjustment according to customer requirements to be achieved without having to alter the formulation or the properties of the anti-corrosion coating. Light-induced cold application thus represents a resource-efficient method, since it not only reduces energy consumption, but also avoids running of the CP system from the components, which results in a large reduction in waste.

In the process of the invention for the anti-corrosion coating of a component, it is clear that the step of irradiating the anti-corrosive with radiation suitable for this purpose or adjusted therefor can also take place before the step of applying an anti-corrosive to the component. In this case, the solidification of the anti-corrosive takes place in a time-adjusted/time-delayed manner, i.e. in such a way that the actual solidification takes place only after the application step. In addition, it is clear that the application of the anti-corrosive to the component also includes application of the anti-corrosive into the component, for example into cavities thereof.

The term “component” as used herein relates to any component, in particular metallic components, for example components of a vehicle body. The component can have any shape. The surface(s) of the component to be protected can be described here as a hypersurface or as a combination of hypersurfaces. For example, the protected surface(s) of the component are all approximately planar.

A “component region” or “region of a component” refers to an approximately planar section of the component in which a spacing between a radiation source and any point on the surface of the component region has a deviation of ±5% or less, preferably 1% or less. The deviation is determined not only by the geometry of the component region, but also by the shape of the irradiated surface and the nature of the radiation source. In the context of the present invention, a punctiform radiation source can be assumed, which simplifies the determination of the spacing. If the spacing between a radiation source and any point on the surface of the component region has the abovementioned deviation of ±5% or less, the surface component is cured essentially uniformly, i.e. in such a way that no difference in flow behavior of the anti-corrosive applied to the component region can be detected. A component of any shape can therefore be subdivided into a multiplicity of component regions, the spacing thereof from the radiation source meeting the abovementioned criterion. The shape of the component regions is selected here in accordance with the surface actually irradiated by the radiation source and is for example circular or square. Thus, by altering the position and/or altering the spacing of the component in respect of the radiation source or vice versa, it is possible for the individual component regions to be successively cured in a desired manner, preferably uniformly.

In the context of the present invention it was also found that uniform curing can likewise be achieved if a ratio V_{(AR/SR)} of the area of the one or more radiation sources (AR) to the surface region (SR) of a component to be coated is 2*10⁻³ or more. That is to say, if the surface region of a component to be coated is 1 m², the combined area of the one or more radiation sources should, if possible, be at least 20 cm². The area of the one or more radiation sources is preferably selected such that the following applies: 3-10⁻³≤V_{(AR/SR)}≤1.0; such as 4-10⁻³≤_{(AR/SR)}≤0.5; 5-10⁻³≤V_{(AR/SR)}≤0.1; 10⁻²≤V_{(AR/SR)}≤0.1. It is clear to those skilled in the art that V_{(AR/SR)} can also be greater than 1. It is also evident that, in the case described herein, the surface region (SR) of a component to be coated must be simultaneously irradiated from the (entire) surface of one or more radiation sources. If more than one radiation source is used, they can be arranged directly next to one another or evenly distributed over the surface to be irradiated.

A “radiation source” or “light source” in the context of the present invention is any radiation device emitting UV light (one or more of UV-A, UV-B, and UV-C), visible light, and/or NIR light. In particular, UV LEDs are used as a radiation source. Preference is given to using lighting devices that are able to completely or partly cover a wavelength spectrum in the range from λ=300 nm to 1600 nm. The following preferably applies: 320 nm≤λ≤500 nm, such as 330 nm≤λ≤490 nm, 340 nm≤λ≤480 nm, 350 nm≤λ≤470 nm, 360 nm≤λ≤460 nm, 370 nm≤λ≤450 nm, 380 nm≤λ≤440 nm, 385 nm≤λ≤435 nm, 390 nm≤λ≤430 nm, 395 nm≤λ≤425 nm, 400 nm≤λ≤420 nm, or 405 nm≤λ≤415 nm. More preferably, LEDs, for example organic LEDs, and/or lasers are used that emit radiation in the wavelength ranges mentioned above. The UV lamps formerly used for photochemically initiated reactions have a significantly higher energy requirement than UV LED lamps. Moreover, the service life of UV LED lamps is appreciably longer and the amount of heat emitted is reduced. UV LEDs are characterized by their good process reliability and their precise adjustability to defined wavelengths.

A further feature of the radiation source besides the wavelength is the radiation intensity acting on the anti-corrosive. For example, it has been shown that an intensity of about 16.00 W or more, for example 16.25 W to 20.00 W, 16.50 W to 19.50 W, 17.00 W to 19.00 W, or 17.20 W to 18.50 W at a wavelength of 365 nm and a distance of 2.5 cm between the radiation source and the active material/anti-corrosion coating is able to achieve rapid solidification, for example t≤5 minutes, such as t≤1 minute or t=0, of the reactive material and thus also of the anti-corrosive. Alternatively, an intensity of about 20.00 W or more, for example 20.25 W to 24.00 W, 20.50 W to 23.50 W, 21.00 W to 23.00 W, 21.50 W to 23.50 W, or 22.00 W to 22.20 W at a wavelength of 385 nm or 405 nm and a distance of 2.5 cm between the radiation source and the active material/anti-corrosion coating results in rapid solidification, for example t≤5 minutes, such as t≤1 minute or t=0, of the reactive material and thus also of the anti-corrosive. On the basis of this information, those skilled in the art can easily determine the radiation intensity for a reactive material, and thus also for the anti-corrosive, as a function of the wavelength of the radiation source. This applies in particular when the reactive material and the anti-corrosive have the constituents and/or concentrations mentioned herein. Moreover, it has been found that the intensity values, as described in the literature (H. Kuchling: Taschenbuch der Physik [Pocketbook of Physics], 17th edition, Fachbuchverlag Leipzig 2001), are proportional to the distance r according to the relationship 1/r².

A “photoinitiator” as used herein refers to chemical compounds that, after absorbing light, in particular UV light, break down in a photolysis reaction and form reactive species which is able to initiate a polymerization reaction. The reactive species are free radicals and/or cations. Examples of photoinitiators include benzophenones, benzoyl ethers, aminoketones, thioxanthones, acylphosphine oxides, sulfonium salts, ferrocenium salts, and iodonium salts. Preferred photoinitiators are α-hydroxy ketones and/or hydroxycyclohexyl phenyl ketones, in particular Omnirad 184 (IGM Resins). Those skilled in the art are familiar with other photoinitiators and the use thereof.

Examples of suitable photoinitiators include one or more compounds such as 2-benzyl-2-dimethylamino-1-(4-morpholinophenyl)-1-butanone, benzil dimethyl ketal-dimethoxyphenylacetophenone, α-hydroxybenzyl phenyl ketone, 1-hydroxy-1-methylethyl phenyl ketone, oligo-2-hydroxy-2-methyl-1-(4-(1-methylvinyl)phenyl)propanone, benzophenone, methyl ortho-benzoylbenzoate, methyl benzoylformate, 2,2-diethoxyacetophenone, 2,2-di-sec-butoxyacetophenone, p-phenylbenzophenone, 2-isopropylthioxanthone, 2-methylanthraquinone, 2-ethylanthraquinone, 2-chloroanthraquinone, 1,2-benzanthraquinone, benzil, benzoin, benzoin methyl ether, benzoin isopropyl ether, α-phenylbenzoin, thioxanthone, diethylthioxanthone, 1,5-acetonaphthalene, 1-hydroxycyclohexyl phenyl ketone, and ethyl p-dimethylaminobenzoate. Further examples of photoinitiators include onium salts, which form a Brønsted acid when irradiated with visible light, and can be found in EP 0 370 693 A2 and EP 1 020 479 A2. Examples of onium salts include triarylsulfonium (TAS) or diaryliodonium salts such as p-(octyloxyphenyl)iodonium, diaryliodonium hexafluoroantimonate, or tolylcumyliodonium tetrakis(pentafluorophenyl)borate.

A “photosensitizer” as used herein refers to a chemical compound that absorbs energy in the form of radiation, in particular UV radiation, from a radiation source and can act as a photochemical catalyst. The photosensitizer can transfer the energy by means of an energy or electron transfer to a second molecule that has different absorption properties but is able to react after the transfer as part of a polymerization reaction.

A “binder” as used herein relates preferably to an organic binder, for example an ester of an unsaturated fatty acid or an unsaturated alkyd resin. Unsaturated alkyd resins can be mono-, di-, tri- or polyfunctional. For example, possible binders include mono-, di-, tri- or polyfunctionally unsaturated (meth)acrylates. The binder can also serve as a reactive diluent. An example of a preferred binder/reactive diluent is acrylate dissolved in trimethylpropane triacrylate, in particular Laromer PR 9052 (BASF SE). Another example of a preferred binder is a) a saturated and unsaturated fatty acid methyl ester and/or b) a polyunsaturated fatty acid methyl ester, for example a vegetable oil methyl ester, in particular a mixture of rapeseed methyl ester and vegetable oil methyl ester biodiesel (RME) (Gustav Heess GmbH).

An ester of an unsaturated fatty acid may be used in the form of a natural oil. Natural oils are oils that can be obtained from plants or animals such as fish. This is particularly preferable, since these compounds are obtained from renewable raw materials and are therefore advantageous in respect of environmental protection. Examples of preferred vegetable oils are linseed oil, castor oil, soybean oil, groundnut oil, sunflower oil, thistle oil, rapeseed oil, tung oil, oiticica oil, cottonseed oil, corn oil, safflower oil, wood oil, colza oil, perilla oil, poppyseed oil, castor oil, sesame oil, wheat germ oil, hemp seed oil, grapeseed oil, walnut oil, refined linseed oil, currant seed oil, perilla seed oil or wild rose oil.

Unsaturated alkyd resins are polyesters that, in an oxidative crosslinking reaction, preferably in the presence of atmospheric oxygen, are able to crosslink with one another at room temperature or at elevated temperatures, with film formation. According to Römpp Chemie Lexikon [Dictionary of chemistry], Georg Thieme Verlag Stuttgart, 9th expanded and revised edition 1989, alkyd resins are polyester resins modified with natural fats and oils and/or synthetic fatty acids that undergo spatial crosslinking. They are produced by the esterification of polyhydric alcohols, preferably trihydric alcohols, with polybasic carboxylic acids. Fatty acid-free polyesters produced from phthalic acid (anhydride) and glycerol can also be regarded as alkyd resins.

The term “reactive material” as used herein relates to the mixture of binder, photoinitiator, and optionally photosensitizer. In the context of the present invention, it has surprisingly been found that, in particular through the choice of said components and/or the concentration thereof, it is possible to easily adjust the behavior and properties of the anti-corrosive, particularly with regard to immediately occurring or time-delayed curing, heat resistance, but also with respect to the light source. Thus, not only the parameters mentioned in the examples, for example light intensity, wavelength, duration of irradiation, individually or in combination, but also the concentration of the individual components, for example with variations in ranges of ±10% or less, ±5% or less, or ±1% or less, may be transferred to another reactive material, i.e. having at least one altered component, i.e. having at least one selected from binders, photoinitiators, and optionally photosensitizers. For example, the light intensity may be reduced by 10% and a different binder selected at the same time. The individual constituents of the reactive material are preferably present in the corresponding concentration as shown in connection with the anti-corrosive. The reactive material therefore comprises 0.1% to 10.0% by weight of at least one photoinitiator, 0.0% to 0.1% by weight of a photosensitizer, and 1.0% to 40.0% by weight of a binder.

The radiation source can comprise any desired surface irradiation, preferably the surface is circular or rectangular, for example square. There is no limit on the number of radiation sources here, which can be 1 or more, for example 2 or more, 3 or more, 4 or more, 5 or more, 10 or more, 100 or more, or 1000 or more. The radiation sources can be arranged in arrays here. These arrays can map individual regions of the surface, i.e. including a corresponding hypersurface or combination of hypersurfaces, as a result of which the even solidification of the coating can be further improved. It is clear that the radiation source(s) and photoinitiator(s), and any photosensitizers optionally present are selected such that the irradiation with the radiation source(s) initiates the photoinitiation and thus the polymerization reaction.

Where a “thick layer” is referred to in the context of the present invention, this means layers having a thickness within a range from 1000 to 8000 μm, preferably 2000 to 7000 μm, 3000 to 6000 μm, 4000 to 5500 μm, 4800 to 5200 μm, 4900 to 5100 μm, or 5000 μm. “Thin layers” refer to layers having a thickness of 10 μm to <1000 μm, preferably 50 μm to 900 μm, 100 μm to 800 μm, 200 μm to 700 μm, 300 μm to 600 μm, or 400 μm to 500 μm. Measurement of the layer thickness as such does not take place, since this brings about a change in the dimension to be determined (for example through the application of pressure to a test specimen). Rather, the layers are produced in the desired/abovementioned thicknesses with a film applicator, in particular a graduated doctor blade in the desired thickness. Film applicators, for example graduated doctor blades, are here preferably used in accordance with the respective manufacturer's instructions. More preferably, BYK-Gardner doctor blades are used to produce the desired layer thicknesses. The layer thickness therefore relates both to the anti-corrosive applied to a component (before irradiation) and to anti-corrosive applied to the component after irradiation has taken place. It is clear that the present invention can be used equally for thin as well as thick layers. Preference is given to using the present invention for thick layers.

“Heat stability” or “heat resistance” as used herein describes the ability of the fully reacted coating to be exposed to an elevated temperature of e.g. 50° C. or more, preferably 70° C. to 100° C. or 75° C. to 95° C., for a defined period of e.g. 5 minutes to 2 hours, preferably 30 minutes to 1 hour, without showing any detectable changes. The heat stability can be carried out for example as shown in example 4.

The term “oil” as used herein is according to Zorll, U. (1998): Römpp Lexikon-Lacke and Druckfarben [Dictionary of paints and inks], Georg Thieme Verlag Stuttgart a collective term relating to organic compounds having similar physical properties. These are insoluble in water and have a very low vapor pressure, which can be regarded as the essential characteristics. Oils are basically divided into three groups: a) mineral oils based on petroleum, fully synthetic oils, b) oils of animal or vegetable origin, and c) essential oils, i.e. oils and fragrances of vegetable origin having corresponding volatility.

An oil is thus different from a “wax”, which according to L. Ivanovszki (1954): Wachsenzyklopädie [Encyclopedia of waxes] volume 1, Augsburg: Verlag für chemische Industrie H. Ziolkowsky K. G. and Ullmann, G. Schmidt, H. Brotz, W. Michalczyk; G. Payer, W. Dietsche, W. Hohner, G. Wildgruber, J. 1983: Wachse [Waxes], in: Bartholomé E., Biekert, E., Hellmann, H, Ley, H., Weigert, W. M. Ullmanns Enzyklopädie der technischen Chemie [Encyclopedia of industrial chemistry] 4th edition, volume 24 Wachse bis Zündhölzer [Waxes to matches], Weinheim: Verlag Chemie, pp. 1-49 is characterized by meeting all of the following characteristics simultaneously: at 20° C. kneadable, firm to brittle-hard; coarsely to finely crystalline, translucent to opaque, but not glass-like; melting above 40° C. without decomposition; relatively low viscosity even at slightly above the melting point; consistency and solubility strongly temperature-dependent; polishable under light pressure.

A “reactive diluent” as used herein is known to those skilled in the art. Examples of such compounds include alkoxylated alkanediol or alkanetriol (meth)acrylates such as 1,3-butylene glycol di(meth)acrylate, butane-1,4-diol di(meth)acrylate, hexane-1,6-diol di(meth)acrylate, trialkylene glycol di(meth)acrylate, polyalkylene glycol di(meth)acrylate, trimethylpropane triacrylate, tetraalkylene glycol di(meth)acrylate, neopentyl glycol di(meth)acrylate, glycerol alkoxy tri(meth)acrylate, alkoxylated neopentyl glycol di(meth)acrylate; (meth)acrylic epoxide compounds, such as bisphenol-A epoxide di(meth)acrylate; polyhydroxy(meth)acrylates, such as pentaerythritol tri(meth)acrylate, trimethylolpropane tri(meth)acrylate, trisalkoxy trimethylolpropane tri(meth)acrylate, di-trimethylolpropane tetra(meth)acrylate, pentaerythritol tetra(meth)acrylate, tris(2-hydroxyalkyl)isocyanurate tri(meth)acrylate, dipentaerythritol tetra(meth)acrylate, dipentaerythritol penta(meth)acrylate, and dipentaerythritol hexa(meth)acrylate.

“Anti-corrosion additives” as used herein relate for example to anti-corrosion pigments and/or corrosion inhibitors and are known to those skilled in the art. Examples of anti-corrosion additives include sulfonate-based compounds, (optionally doped) silica, for example calcium-modified silica, silicates of divalent metals, aluminum and zinc phosphates and modifications thereof, surface-modified titanium dioxide, alkoxy titanates, titanium acylates, silanes, benzothiazole derivatives, zinc or calcium gluconates, salicylic acid derivatives, and phosphoric esters of alkoxylated cellulose (cellulose phosphate).

Various additives, including anti-corrosion additives may be added to the anti-corrosive in the form of pre-prepared mixtures. Exemplary and preferred pre-prepared mixtures comprise one or more of an alkyd resin, anti-corrosion additive, mineral oil, pigment, thixotropic agent, and optionally further additives. Particular preference is given to AP 38-03 (Pfinder KG) and alkyd resins, sulfonate-based anti-corrosion additives, mineral oil, pigments, thixotropic agents, and optionally other additives.

Terms such as “time-adjusted” and “time-delayed” as used herein relate to a set/adjustable time delay to solidification of the anti-corrosive of the invention after irradiation has taken place. There are no limits on the duration of the time delay, which can be selected/set in accordance with individual requirements of e.g. the product, the production facility, or customer wishes. Examples of time intervals include 5 seconds to 48 hours, for example 1 minute to 24 hours, 5 minutes to 12 hours, 10 minutes to 6 hours, 20 minutes to 3 hours, or 30 minutes to 1 hour. This is determined in the context of the present invention by one or more factors, in particular the composition of the anti-corrosive of the invention, the surface, in particular surface shape, of the component to be coated, and irradiation parameters. The latter relate, for example, to the wavelength of the radiation, the radiation intensity, the duration of irradiation, and the shape and number of the radiation source(s) employed. Further parameters, for example a measure of the energy converted by the radiation source into the corresponding radiation and the distance between the radiation source and the anti-corrosive at the time of irradiation, can be subsumed under the radiation intensity.

A “motor vehicle component” as used herein relates for example to a component of a car, truck, heavy goods vehicle or special-purpose vehicle, bus, motor-driven two-wheeler, an agricultural or construction machine, an aircraft, a flight vehicle, a means of maritime transport, for example a boat or ship, an internal combustion engine, a hybrid drive, or an electric drive.

In a preferred embodiment of the present invention, the at least one photoinitiator is selected from the group consisting of a benzophenone, benzoyl ether, aminoketone, thioxanthone, acylphosphine oxide, sulfonium salt, ferrocenium salt, and iodonium salt.

The photoinitiator can be used individually or in a mixture with other photoinitiators and optionally combined with aminic accelerators known in the prior art.

In another preferred embodiment of the present invention, the binder is selected from the group consisting of an acrylate, for example a polyurethane acrylate, polyester acrylate or epoxy acrylate, unsaturated polyesters and thiol-ene system, vinyl ethers, and heterocycles.

Thiol-ene systems relate to components able to undergo the thiol-ene reaction (a hydrothiolation of alkenes) with the formation of an alkyl sulfide. Suitable heterocycles include for example cyclic ethers such as epoxides, oxetanes, and/or lactones, lactams or combinations thereof.

In yet another preferred embodiment of the present invention, the anti-corrosive comprises 4.0% to 6.0% by weight of the at least one photoinitiator, 0.0% to 0.1% by weight of a photosensitizer, 32.0% to 37.0% by weight of a binder-reactive diluent mixture, and 18.0% to 22.0% by weight of an oil-wax mixture. Here, the at least one photoinitiator is a hydroxy ketone and a hydroxycyclohexyl phenyl ketone and the binder is an acrylate. The oil and the wax are a saturated and unsaturated fatty acid or long-chain, saturated, branched or cyclic hydrocarbons, the reactive diluent more preferably being trimethylpropane triacrylate. It is clear that further constituents, for example additives and/or anti-corrosion additives, may be present.

In another preferred embodiment of the present invention, a heat resistance of the anti-corrosion coating is adjusted and/or can be set.

The heat resistance may be adjusted and/or set to a defined increased temperature of e.g. 50° C. or more, preferably 70° C. to 100° C. or 75° C. to 95° C., for a defined period of e.g. 5 minutes to 2 hours, preferably 30 minutes to 1 hour. The adjustment of the heat resistance to an increased temperature can be improved e.g. by the inclusion of fillers such as e.g. silicates or aluminum hydroxide.

In another preferred embodiment of the present invention, at the end of irradiation the anti-corrosive remains flowable for a period t of 5 minutes or longer and thereafter solidifies, even in thick layers, within the range from 1000 to 8000 μm, for example 5000 μm.

At the end of irradiation, a desired heat resistance up to a target temperature T≥95° C. is preferably already achieved after t=30 minutes at layer thicknesses of d≤500 μm.

In yet another preferred embodiment of the present invention, the viscosity of the flowable anti-corrosive at room temperature at the end of irradiation is 10¹ mPa·s to 10⁶ mPa·s.

Anti-corrosives of this type preferably include further additives, for example anti-corrosion additives such as for example flexibilizers (internal plasticizers), such as for example mineral oil, fillers such as for example talc, kaolin, aluminum hydroxide, silicates or calcium carbonates, rheological additives such as for example inorganic thickeners, for example, organic or inorganic bases, which likewise contribute to corrosion protection, catalysts for the oxidative curing of the anti-corrosive, such as for example cobalt salts and other ingredients, for example to prevent skin formation when left to stand, for example 2-butanone oxime (MEKO). Colorants, in particular pigments, may likewise be present in the anti-corrosive.

In another preferred embodiment of the present invention, the system remains flowable for 0.01≤t≤2 hours after irradiation has been carried out.

This allows the applied anti-corrosive to be evenly distributed by moving, for example turning, the component, and enabling it e.g. to reach inaccessible points in the component. The component is preferably subdivided into individual component regions in the manner mentioned above, these being successively irradiated by a single radiation source or a plurality thereof. This allows influences of the component geometry on curing of the applied anti-corrosive to be reduced or avoided altogether.

The component can thus have a first surface region R₁ and a second surface region R₂, the first surface region R₁ being irradiated with a first intensity I₁ and a first light wavelength L₁ for a first period t₁ and the second surface region R₂ being irradiated with a second intensity I₂ and a second light wavelength L₂ for a second period t₂, wherein one or more of the following applies: (i) the first intensity I₁ may be different from the second intensity I₂, (ii) the first light wavelength L₁ may be different from the second light wavelength L₂, and (iii) the first period t₁ may be different from the second period t₂.

Preferably, a ratio Vₗ of the first intensity I₁ to the second intensity I₂ is 1.01≤Vₗ≤10.0 and/or a ratio Vₜ of the first period t₁ to the second period t₂ 1.01≤Vₜ≤10.0.

In yet another preferred embodiment of the present invention, the application of an anti-corrosive to the component includes: spraying an anti-corrosive into/onto the component, and allowing the anti-corrosive to penetrate/run.

For example, it is possible within the period t of 5 minutes or longer for excess anti-corrosive to drip out of the component and/or anti-corrosive to flow into an accessible point on the component by moving the component.

In a preferred embodiment of the present invention, the entire process takes place at a temperature of ≤30° C.

The stated temperature is accordingly not exceeded at any time.

If the entire process takes p[lace at a temperature of ≤30° C., for example ≤28° C., ≤26° C., ≤25° C., ≤24° C., ≤23° C., ≤22° C., ≤21° C. or ≤20° C., it is referred to in the context of the present invention as a cold application. Cold application can save cost-, energy- and time-intensive process steps, for example drying zones.

In another preferred embodiment of the present invention, one or more of the following is adjustable: (i) a position L of the at least one radiation source in relation to the component, (ii) an intensity I of the radiation source, and (iii) a period t of irradiation of the component.

The position L here describes the position of the radiation source in relation to the (irradiated) section of the component surface, taking into account the distance of the radiation source from the component (region) and possibly the geometry of the component (region) and/or nature of the radiation source. A punctiform radiation source is preferably assumed, in which case the nature of the radiation source can be disregarded. Altering the distance between the radiation source and the component (region) allows the radiation intensity to be altered or varied, for example by reducing or increasing the distance during irradiation.

In yet another preferred embodiment of the present invention, in the anti-corrosive of the invention, the process of the invention or the system of the invention, the anti-corrosive is a cavity preservation agent, an agent for underbody protective coating, an agent for permanent protective coating for storage and transport, or an agent for temporary protective coating for storage and transport. The component is preferably a motor vehicle component.

Anti-corrosives such as for example cavity preservation agents usually include as ingredients inter alia anti-corrosion additives such as for example calcium sulfonate, oxidatively crosslinking binders such as for example alkyd resins, flexibilizers such as for example mineral oil, fillers such as talc, rheological additives such as for example inorganic thickeners, e.g. bentonites, organic or inorganic bases that likewise contribute to corrosion protection, such as for example triethylenediamine, catalysts for the oxidative curing of the binder, such as for example cobalt salts, and other additives, e.g. to prevent skin formation when left to stand, such as for example 2-butanone oxime.

Any compound or mixture of compounds crosslinkable by reaction with another compound is suitable as the crosslinkable component, provided said component is compatible with the anti-corrosive, for example with the cavity preservation agent, does not hinder the anti-corrosion effect thereof, and does not impair the flexibility and plasticity of the finished anti-corrosion coating, e.g. of cavity sealing.

The crosslinking component may include any compound or mixture of compounds that is able to undergo a crosslinking reaction with the crosslinkable component and that does not impair the anti-corrosion effect or the flexibility and plasticity of the anti-corrosion coating, e.g. of cavity sealing.

The exact combination of crosslinkable component and crosslinking component and the amounts used thereof can be determined by those skilled in the art, by means of methods known to them, in respect of the desired gelation time and also the degree of solidification and the nature of the cavity preservation agent used.

A preferred anti-corrosive includes, based on 100% by weight of the anti-corrosive: 0.1% to 10.0% by weight of at least one photoinitiator, for example an α-hydroxyketone/hydroxycyclohexyl phenyl ketone, in particular Omnirad 184; 1.0% to 40.0% by weight of a binder, for example an acrylate dissolved in trimethylpropane triacrylate, in particular Laromer PR 9052; 10.0% to 50.0% by weight of a 100% CP system without DropStop, in particular AP 38-03; and 10.0% to 35.0% by weight of a mixture of saturated and unsaturated fatty acids, in particular RME. It is clear that further of the compounds mentioned above, for example additives, etc., may be present in the amounts mentioned.

It is understood that the features mentioned above and those still to be explained hereinbelow may be employed not just in the respectively specified combination, but also in other combinations or on their own, without departing from the scope of the present invention.

### BRIEF DESCRIPTION OF THE DRAWINGS

In the figures,

FIG. 1 shows a schematic representation of the different application methods,

FIG. 2 shows a schematic representation of the various exposure times of the samples,

FIGS. 3A-3F show the different run distances of samples as a function of irradiation intensity and wavelength,

FIGS. 4 to 6, 7A, and 7B show the run distance length as a function of wavelength and irradiation intensity at various irradiation times,

FIGS. 8 to 12 show the complete curing of a sample as a function of wavelength and irradiation intensity at various irradiation times,

FIGS. 13A-13B show the heat resistance of a sample (right) and of an unexposed reference “blank sample” (left), and

FIG. 14 shows a schematic representation of the relationships between the run distance and the various parameters.

### EMBODIMENTS

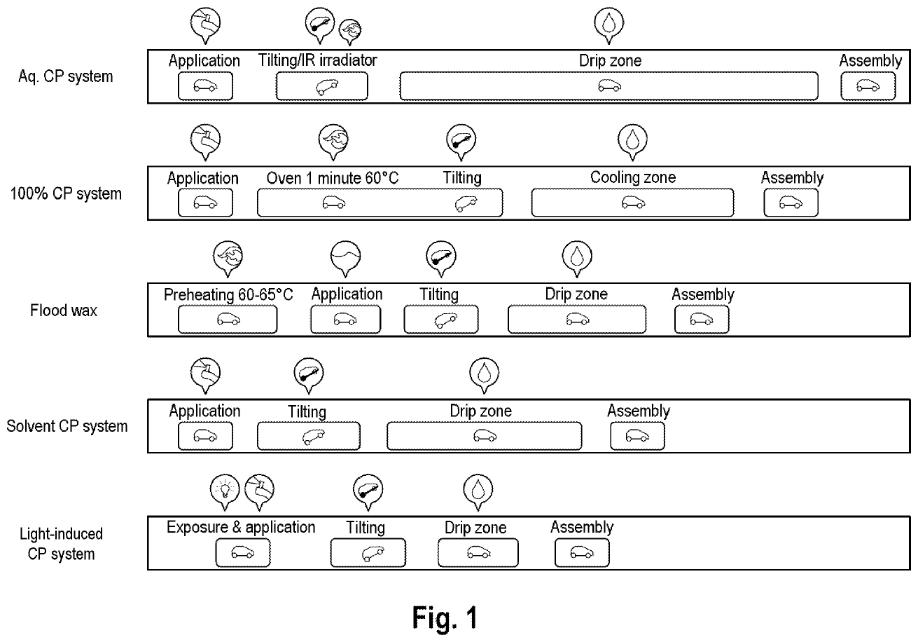

FIG. 1 shows a schematic representation of the application methods for solvent CP systems, aqueous CP systems, and 100% CP systems according to the prior art. Also shown is the inventive cold-application method for a light-induced CP system. As mentioned, running zones and/or complex masking of components such as for example rocker panels are necessary when applying conventional CP systems. In addition, ovens are used to achieve complete evaporation of the medium or initiation of the DropStop. The schematic representation of the different application methods shows that the use of a light-induced cold-application method makes it possible to dispense with the abovementioned measures individually or in their entirety, allowing savings to be achieved on costs, energy, and time.

The light-induced CP system can accordingly be limited to the steps of light exposure (irradiation), application, optionally tilting of the component, and optionally allowing excess anti-corrosive to drip off. The component (body) can thus be supplied for assembly without the need for intermediate storage. As stated above, the light exposure and application steps can take place in any order. Thus, the anti-corrosive can be irradiated before and/or during application to a component, provided curing of the anti-corrosive takes place with a time delay. Alternatively, it is possible for the anti-corrosive to be applied to the component, with irradiation and curing carried out subsequently (immediately thereafter or with a time delay).

### EXAMPLES

In the examples shown below all data in %, unless explicitly stated otherwise, refer to % by weight. In addition, unless explicitly stated otherwise, the sample (P_1b) having the composition described in Table 2 is assumed. Parameters once described likewise apply to further test parameters, unless explicitly stated otherwise. For example, the spacing or intensity of the radiation source is specified with reference to example 1. These parameters are the same in the other examples.

### Example 1: Dependence on the Wavelength, Irradiation Time, and Irradiation Intensity

A sample (P_1b) is cured with each of three wavelengths (365 nm, 385 nm, and 405 nm) for different irradiation times (60 s, 10 s, 5 s, 2 s, 1 s, 0.5 s, and 0 s) and with each of two different irradiation intensities (100% and 15%) at a distance of 2.5 cm between the sample and the radiation source. Table 1 gives the intensity values of the various wavelengths. It has been shown that the intensity values, as described in the literature (H. Kuchling: Taschenbuch der Physik [Pocketbook of Physics], 17th edition, Fachbuchverlag Leipzig 2001), are proportional to the distance r according to the relationship 1/r². The intensities in Table 1, which were determined at a distance of 4.5 cm, can on this basis be readily applied to the distance of 2.5 cm, as shown in the further examples.

TABLE 1
Intensity values of the different
wavelengths at a
distance of 4.5 cm between the
measuring cell and
the radiation source

| Wavelength | Intensity | Intensity |
|---|---|---|
| in nm | 15% in W | 100% in W |
| 365 | 0.82 | 5.31 |
| 385 | 1.14 | 6.91 |
| 405 | 1.11 | 6.83 |

The sample P_1b has the composition shown in Table 2. The sample may comprise further constituents of the anti-corrosive of the invention in the amounts listed. These additional constituents have been shown not to affect the properties shown below.

TABLE 2
Composition of the sample P_1b

| | | Amount used |
|---|---|---|
| Name | Material | in % |
| Omnirad | α-Hydroxyketone/hydroxy- | 4.8 |
| 184 | cyclohexyl phenyl ketone | |
| Laromer PR | Acrylate dissolved in | 34.8 |
| 9052 | trimethylpropane triacrylate | |
| AP 38-03 | 100% CP agent without DropStop | 40 |
| RME | Saturated and unsaturated | 20 |
| | fatty acids | |

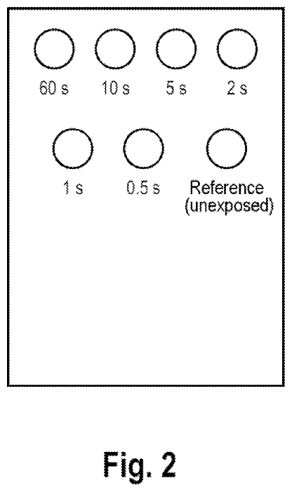

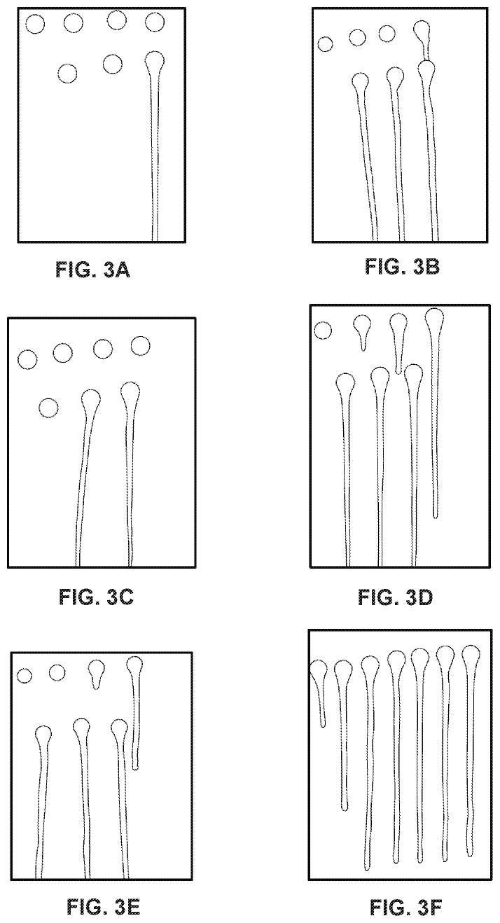

FIG. 2 shows a schematic representation of the various exposure times of the samples including control. The samples and control are here not necessarily in two rows (FIGS. 3A-3E), but may also be in one row in a corresponding sequence (FIG. 3F).

100 μl droplets are dripped onto a sheet steel (20 cm×50 cm) coated by cathodic dip painting (CDP) (for example a sheet steel coated with CathoGuard 800 or 900 (BASF SE)) and irradiated. After irradiation, the sheet is stood in an upright position. After 10 minutes, the run distance (=distance traveled by the sample on the sheet) is measured and also documented with a photograph. The sequence of the different exposure times is maintained here (see FIG. 2).

FIGS. 3A-3F show the different run distances of the droplets as a function of irradiation intensity (100% in FIGS. 3A, 3C, 3E; 15% in FIGS. 3B, 3D, 3F) and wavelength (365 nm in FIGS. 3A, 3B; 385 nm in FIGS. 3C, 3D; 405 nm in FIGS. 3E, 3F).

As expected, a shorter wavelength and longer exposure time achieve a shorter run distance and the irradiated droplet has higher strength (gel strength). At 365 nm and 100% irradiation intensity, all droplets solidify and only the unexposed reference has a run distance of 19 cm. Even the longest irradiation time of 60 s does not result in complete solidification (gelation) of the droplet at 405 nm and 15% intensity and instead a run distance of 6 cm is obtained.

Table 3 shows the run distance in cm as a function of wavelength, irradiation time, and irradiation intensity. The samples contain 4.8% Omnirad 184, 34.8% Laromer PR 9052, 20% RME, and 40% AP 38-03 (as per Table 2). In each case 100 μl of sample is applied in the form of a droplet to the CDP sheet and irradiated. The sheet is then stood in an upright position for 10 minutes. The mark¹ indicates measurement according to the method specified herein. The mark² refers to “oil running”, wherein a uniform run distance is not achieved.

TABLE 3
Run distance in cm as a function of wavelength,
irradiation time, and irradiation intensity.

| Wave- | | Run distance¹ in cm as a function | | | | | | |
|---|---|---|---|---|---|---|---|---|
| length | Intensity | of irradiation time | | | | | | |
| in nm | in % | 0 s | 0.5 s | 1 s | 2 s | 5 s | 10 s | 60 s |
| 365 | 15 | 24 | 22 | 21 | 5 | 0 | 0 | 0 |
| | 100 | 19 | 0 | 0 | 0 | 0 | 0 | 0 |
| 385 | 15 | 22 | 22 | 20 | 22 | 6.5 | 3² | 4.5² |
| | 100 | 23 | 17 | 3 | 0 | 0 | 0 | 0 |
| 405 | 15 | 24 | 23 | 23 | 24 | 24 | 17 | 6 |
| | 100 | 22 | 24 | 21.5 | 11.5 | 3 | 0 | 0 |

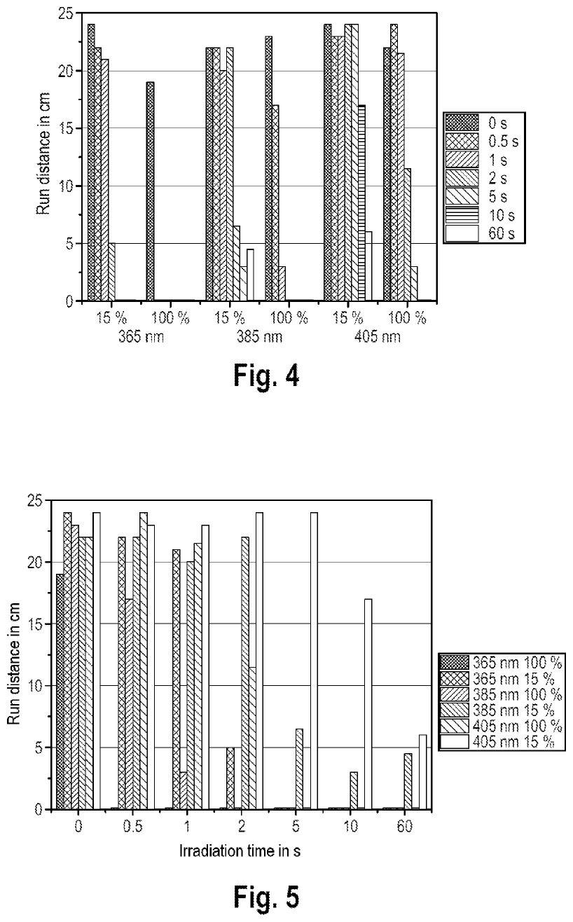

FIG. 4 shows the run distance in cm plotted against the wavelength and irradiation intensities for different irradiation times. Sample containing 4.8% Omnirad 184, 34.8% Laromer PR 9052, 20% RME, and 40% AP 38-03. 100 μl sample, irradiated, metal sheet stood in an upright position for 10 min.

FIG. 5 shows the run distance in cm plotted against the irradiation time at various wavelengths and different irradiation intensities. The sample contains 4.8% Omnirad 184, 34.8% Laromer PR 9052, 20% RME, and 40% AP 38-03 (as per Table 2). A droplet of in each case 100 μl of sample is applied to a metal sheet, irradiated, and the metal sheet is stood in an upright position for 10 min.

A correlation between run distance, wavelength, and irradiation time is evident: the longer the droplet is irradiated, the shorter the run distance (and the tougher the surface film and the deepening gelation brought about by the crosslinking reaction). And in addition: the higher the irradiation intensity, the shorter the run distance (FIGS. 3A-3F). The intensity of a system tailored to the wavelength has a greater effect on the run distance than on the wavelength itself, since with an irradiation time of 1 s and at 365 nm and 15% a run distance of 21 cm is obtained and at 385 nm and 100% the run distance is only 3 cm.

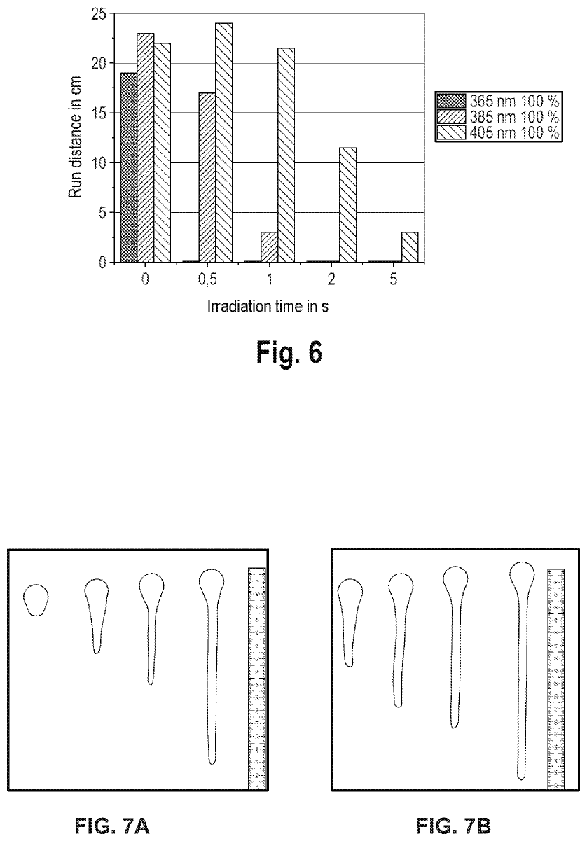

FIG. 6 shows the run distance for an irradiation intensity of 100% only. With the same irradiation time and intensity, the run distance is longer at lower light energy (longer wavelength). For example, the run distance at 1 s and 100% irradiation intensity is 3 cm long at 385 nm, but 21.5 cm long at 405 nm.

### Example 2: Concentration Dependence

The concentration is another parameter with which the run distance can be controlled. As expected, a smaller proportion of reactive material (mixture of binder, photoinitiator and photosensitizer) results in less pronounced gelation of the droplet and thus in longer run distances.

Table 4 shows the run distances in cm as a function of wavelengths, irradiation times, and irradiation intensities. In each case 100 μl of sample is irradiated and the metal sheet is stood in an upright position for 10 min. Sample: P_1d (0.13% Omnirad 184, 6.53% Laromer PR 9052, 73.3% AP 38-03, and 20% RME). Sample: P_1e (0.02% Omnirad 184, 1.2% Laromer PR 9052, 78.7% AP 38-03, and 20% RME). The mark¹ indicates measurement according to the method specified herein.

TABLE 4
Run distance in cm as a function of wavelength,
irradiation time, and irradiation intensity.

| | | | Run distance¹ in cm | | | |
|---|---|---|---|---|---|---|
| | | | as a function of | | | |
| | Wavelength in | Intensity in | irradiation time in s | | | |
| Sample | nm | % | 0 | 5 | 10 | 60 |
| P_1d | 365 | 100 | 15 | 3 | 2.5 | 0 |
| | 405 | 15 | 15 | 8.5 | 6 | 2.5 |
| P_1e | 365 | 100 | 17 | 12.5 | 10.5 | 6.5 |

FIGS. 7A and 7B show the run distances of samples with an exposure time of: 60 s, 10 s, 5 s, and 0 s (from the left). FIG. 7A shows the run distances of sample P_1d (0.13% Omnirad 184, 6.5% Laromer PR 9052, 73.3% AP38-03, and 20% RME) at a wavelength of 405 nm with 100% intensity. FIG. 7B shows the run distance of sample P_1e (0.02% Omnirad 184, 1.2% Laromer PR 9052, 78.7% 38-03, and 20% RME) at a wavelength of 365 nm with 100% intensity. Thus in FIG. 7A the run distances are about 0.5 cm, 7 cm, 9 cm, and 15 cm, and in FIG. 7B the run distances are about 7.5 cm, 11 cm, 12.5 cm, and 16.5 cm.

With 0.13% Omnirad 184 and 6.53% Laromer PR 9052, the sample P_1d has a relatively low proportion of reactive material and can still be (at least partially) gelled at 405 nm and an intensity of 100% (see FIG. 7A).

At 365 nm and 100%, the run distance of sample P_1e (0.02% Omnirad 184 and 1.2% Laromer PR 9052) can be varied through exposure times of different length (see FIG. 7B).

This means that, even with a very low concentration of the reactive material (approx. 1%), it is possible to achieve a reduction in run distance (see FIG. 7B) through high light intensity (100%) and high light energy (wavelength: 365 nm).

### Example 3: Complete Curing

Well test: 1 ml of a sample P1_b is pipetted into a well having a constant depth of 5000 μm and a volume of 1 ml and irradiated. The well is then stood in an upright position. It is observed whether the sample runs out of the well or develops a convexity.

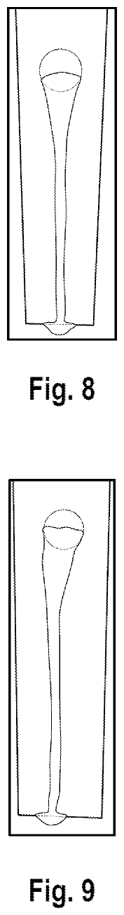

Unirradiated reference: As soon as the well is stood in an upright position, the unirradiated sample material runs out of the well. The (unirradiated) material has very low viscosity and accordingly runs out of the well in liquid form (FIG. 8).

Irradiation of the sample at a wavelength of 405 nm for 10 s and an intensity of 15%: Irradiation with light having a wavelength of 405 nm, a light intensity of 15%, and an exposure time of 10 s is not sufficient to completely gel the material, with the result that it does not remain in the well after the well has been stood upright. A thin skin appears to form in the region of the interface layer exposed to radiation. However, this is not sufficient to hold back the unirradiated, underlying and therefore still liquid material (FIG. 9).

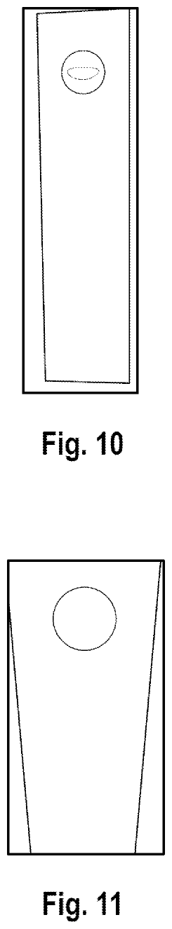

Irradiation of the sample at a wavelength of 365 nm for 10 s and an intensity of 15%: After irradiation with 365 nm and 15% for 10 s, the sample material does not run off as a result of being stood upright, but a clearly visible convexity develops. This indicates the presence of a superficial, highly flexible, and elastic layer that is evidently thicker than in the previous experiment (405 nm, 15%, 10 s). The convexity indicates incomplete gelation (FIG. 10).

Irradiation of the sample at a wavelength of 365 nm for 60 s and an intensity of 15%: The irradiation at 365 nm and 15% for 60 s is sufficient to solidify the entire material. After the well has been stood upright, no material runs out and no convexity is discernible (FIG. 11).

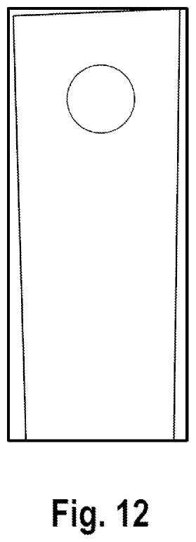

Irradiation of the sample at a wavelength of 365 nm for 10 s and an intensity of 100%: The irradiation at 365 nm and a light intensity of 100% for only 10 s is likewise sufficient to solidify all of the material in the well. Being stood upright neither causes running nor the development of a convexity (FIG. 12).

By irradiating at different wavelengths with varying intensities and irradiation times, the materials (sample P1_b) can be completely gelled for a layer thickness of 5000 μm. All of the variations in parameters mentioned thus far contribute to making the material drip-free.

### Example 4: Heat Stability

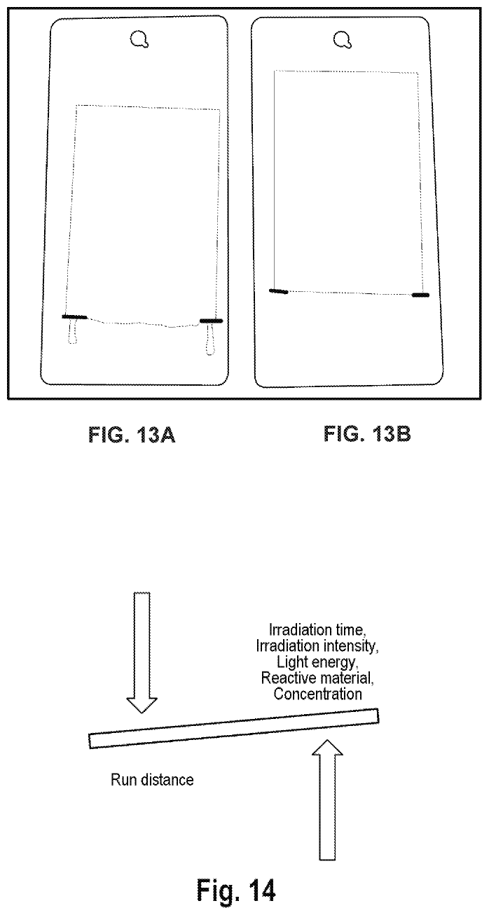

The thermal load capacity is determined by the heat stability of a material. For this purpose, a defined wet film thickness is applied to a cold-rolled sheet steel with the aid of a film-drawing frame. With conventional CP materials, activation and seasoning to solidify the samples must be taken into account after application. To analyze the heat stability, some material is removed from the lower third of the metal sheet using a spatula. The lower edge is marked with a felt pen. The samples are then heated in an oven at defined temperatures and the run-off behavior under the influence of temperature is observed (FIG. 13).

To investigate the heat resistance of the light-induced crosslinking material, the material (sample P1_b) is applied to two metal sheets, in each case with a wet film thickness of 500 μm. The material is then irradiated for 10 s with a wavelength of 365 nm and a radiation intensity of 100%.

The heat resistance of the unexposed blank sample (FIG. 13A) and of the exposed sample (FIG. 13B) is examined in an oven at 95° C. In the case of the blank sample, running was not seen until reaching a temperature of 75° C., whereas the irradiated sample showed no tendency to run even at a temperature of 95° C. These results suggest that the irradiation immediately crosslinks the material. There are therefore no concerns about running from components, even at very high temperatures.

It is possible to control the run distance via parameters such as irradiation time, light energy, irradiation intensity, and proportion of reactive material, it being possible to use any mixtures of reactive materials that differ both in respect of the individual component as such and in the amount thereof.

Depending on the technical options (for example the radiation source), the parameters can be altered in order to adjust the run distance. If, for example, a radiation source delivers only low irradiation intensities, the run distance can be controlled by means of a longer irradiation time (see FIG. 14).

It has also been shown that the heat stability (layer thickness of 500 μm) is achieved immediately after irradiation (365 nm, 100% 10 s). This is due to the fact that the material does not require any post-crosslinking time. The material is accordingly drip-free and temperature-resistant immediately after application and subsequent irradiation.

It has moreover been demonstrated that solidification of thick layers of e.g. 5000 μm can be readily achieved with irradiation of sufficient intensity and with a sufficiently long irradiation time.

The disclosure further comprises embodiments as set out in the clauses shown below.

Clause 1. An anti-corrosive that is a cavity preservation agent, an agent for underbody protective coating, an agent for permanent protective coating for storage and transport, or an agent for temporary protective coating for storage and transport, the anti-corrosive being intended for the corrosion protection of a component, in particular of a motor vehicle part, wherein the anti-corrosive can be applied without additional heating, undergoes radiation-induced free radical and/or cationic crosslinking, preferably in thick layers, and has application-based, controllable reaction kinetics and an adjusted heat resistance.
Clause 2. An anti-corrosive, comprising or consisting of:

0.1% to 10.0% by weight of at least one photoinitiator,

0.0% to 0.1% by weight of a photosensitizer,

1.0% to 40.0% by weight of a binder,

0% to 10.0% by weight of a reactive diluent,

0.1% to 10.0% by weight of an additive,

5.0% to 50.0% by weight of an oil,

1.0% to 20.0% by weight of a wax,

1.0%, to 40.0% by weight of an anti-corrosion additive, and

0.0% to 20.0% by weight of a filler and/or a pigment, based on 100% by weight of the anti-corrosive, the anti-corrosive including at least one photoinitiator, the photoinitiator and/or the photosensitizer being tailored to the absorption of radiation, wherein the anti-corrosive is at the end of irradiation solid or else solidifies in a time-adjusted manner.

Clause 3. The anti-corrosive according to clause 2, wherein at least one photoinitiator is selected from the group benzophenone, benzoyl ether, aminoketone, thioxanthone, acylphosphine oxide, sulfonium salt, ferrocenium salt, and iodonium salt.
Clause 4. The anti-corrosive according to either of clauses 2 or 3, wherein the binder is selected from the group consisting of an acrylate, for example a polyurethane acrylate, polyester acrylate or epoxy acrylate, unsaturated polyesters and thiol-ene system, vinyl ethers and heterocycles.
Clause 5. The anti-corrosive according to any of the clauses 2 to 4, wherein the anti-corrosive comprises 4.0% to 6.0% by weight of the at least one photoinitiator, 0.0% to 0.1% by weight of a photosensitizer, 32.0% to 37.0% by weight of a binder-reactive diluent mixture, and 18.0% to 22.0% by weight of an oil-wax mixture, preferably wherein the at least one photoinitiator is a hydroxy ketone and a hydroxycyclohexyl phenyl ketone, wherein the binder is an acrylate, wherein the oil and the wax are a saturated and unsaturated fatty acid or long-chain, saturated, branched or cyclic hydrocarbons, the reactive diluent more preferably being trimethylpropane triacrylate.
Clause 6. An anti-corrosion coating of a component according to any of the preceding clauses, wherein a heat resistance of the anti-corrosion coating can be adjusted and/or set.
Clause 7. A process for the anti-corrosion coating of a component, including or consisting of:

applying an anti-corrosive to the component, the anti-corrosive including at least one photoinitiator and optionally a photosensitizer,

irradiating the anti-corrosive with radiation tailored to absorption by the at least one photoinitiator and by any optional photosensitizer, wherein the anti-corrosive is at the end of irradiation solid or else solidifies in a time-adjusted manner.

Clause 8. The process for the anti-corrosion coating of a component according to clause 7, wherein the anti-corrosive at the end of irradiation remains solid and/or flowable for a period t of 5 minutes or longer and thereafter solidifies, even in thick layers, within the range up to 5000 μm.
Clause 9. The process according to either of clauses 7 to 8, wherein the viscosity of the flowable anti-corrosive at room temperature at the end of irradiation is 10¹ mPa·s to 10⁶ mPa·s.
Clause 10. The process according to any of clauses 7 to 9, wherein 0.01 hours≤t≤2 hours.
Clause 11. The process according to any of clauses 7 to 10, wherein the application of an anti-corrosive to the component includes:

spraying an anti-corrosive into/onto the component and allowing the anti-corrosive to penetrate/run.

Clause 12. The process according to any of clauses 7 to 11, wherein the entire process takes place at a temperature of 30° C.
Clause 13. A system for the anti-corrosion coating of a component, including or consisting of:

an anti-corrosive, preferably an anti-corrosive as claimed in any of clauses 1 to 6, that is applied to the component, the anti-corrosive including at least one photoinitiator and/or photosensitizer,

at least one radiation source for the irradiation—which can take place before, during or after application and inside or outside the component—of the anti-corrosive with radiation tailored to absorption by at least one photoinitiator and/or photosensitizer, wherein the anti-corrosive is at the end of irradiation solid or else solidifies in a time-adjusted manner.

Clause 14. The system according to clause 13, wherein one or more of the following is adjustable: (i) a position L of the at least one radiation source in relation to the component, (ii) an intensity I of the radiation source, and (iii) a period t of irradiation of the component.
Clause 15. The anti-corrosive according to any of clauses 1 to 6, the process as claimed in any of clauses 7 to 12, or the system as defined in either of clauses 13 or 14, wherein the anti-corrosive is a cavity preservation agent, an agent for underbody protective coating, an agent for permanent protective coating for storage and transport, or an agent for temporary protective coating for storage and transport, the component preferably being a motor vehicle component.

What is claimed is:

1. A process for the anti-corrosion coating of a motor vehicle component, wherein the anti-corrosive is a cavity preservation agent or an agent for underbody protective coating, the process comprising the steps:
applying an anti-corrosive to the component, the anti-corrosive including at least one photoinitiator and optionally a photosensitizer,
irradiating the anti-corrosive with radiation tailored to absorption by the at least one photoinitiator and by any optional photosensitizer, wherein the anti-corrosive is at the end of irradiation solid or else solidifies in a time-adjusted manner, the anti-corrosive comprising:
0.1% to 10.0% by weight of at least one photoinitiator,
0.0% to 0.1% by weight of a photosensitizer,
1.0% to 40.0% by weight of a binder,
0% to 10.0% by weight of a reactive diluent,
0.0% to 10.0% by weight of an additive,
5.0% to 50.0% by weight of an oil,
1.0% to 20.0% by weight of a wax,
0.0% to 40.0% by weight of an anti-corrosion additive, and
0.0% to 20.0% by weight of a filler and/or a pigment, based on 100% by weight of the anti-corrosive, the coating having a thickness of 50 to 8000 μm.

2. The process for the anti-corrosion coating as claimed in claim 1, wherein the anti-corrosive at the end of irradiation remains solid and/or flowable for a period t of 5 minutes or longer and thereafter solidifies, even in thick layers, within the range up to 5000 μm.

3. The process as claimed in claim 1, wherein the viscosity of the flowable anti-corrosive at room temperature at the end of irradiation is 10¹ mPa·s to 10⁶ mPa's.

4. The process as claimed in claim 2, wherein 0.1 hours≤t≤2 hours.

5. The process as claimed in claim 1, wherein the application of an anti-corrosive to the component step includes the steps of:
spraying an anti-corrosive into/onto the component and
allowing the anti-corrosive to penetrate/run.

6. The process as claimed in claim 1, wherein the entire process takes place at a temperature of ≤30° C.

7. The process as claimed in claim 1, wherein the at least one photoinitiator is selected from the group benzophenone, benzoyl ether, aminoketone, thioxanthone, acylphosphine oxide, sulfonium salt, ferrocenium salt, and iodonium salt.

8. The use as claimed in claim 1, wherein the binder is selected from the group consisting of an acrylate, for example a polyurethane acrylate, polyester acrylate or epoxy acrylate, unsaturated polyesters and thiolene system, vinyl ethers and heterocycles.

9. The process as claimed in claim 1, wherein the anti-corrosive comprises 4.0% to 6.0% by weight of the at least one photoinitiator, 0.0% to 0.1% by weight of a photosensitizer, 32.0% to 37.0% by weight of a binder-reactive diluent mixture, and 18.0% to 22.0% by weight of an oil-wax mixture, preferably wherein the at least one photoinitiator is a hydroxy ketone and a hydroxycyclohexyl phenyl ketone, wherein the binder is an acrylate, wherein the oil and the wax are a saturated and unsaturated fatty acid or long-chain, saturated, branched or cyclic hydrocarbons, the reactive diluent more preferably being trimethylpropane triacrylate.

10. System for performing the process for the anti-corrosion coating of a motor vehicle component as claimed in claim 1, the system comprising:
an anti-corrosive, the anti-corrosive comprising:
0.1% to 10.0% by weight of at least one photoinitiator,
0.0% to 0.1% by weight of a photosensitizer,
1.0% to 40.0% by weight of a binder,
0% to 10.0% by weight of a reactive diluent,
0.0% to 10.0% by weight of an additive,
5.0% to 50.0% by weight of an oil,
1.0% to 20.0% by weight of a wax,
0.0% to 40.0% by weight of an anti-corrosion additive, and
0.0% to 20.0% by weight of a filler and/or a pigment, based on 100% by weight of the anti-corrosive, the coating having a thickness of 50 to 8000 μm,
at least one radiation source for the irradiation of the anti-corrosive with radiation tailored to absorption by at least one photoinitiator and/or photosensitizer, wherein the anti-corrosive is at the end of irradiation solid or else solidifies in a time-adjusted manner.
